(19) United States
(12) Patent Application Publication
(10) Pub. No.: US 2010/0303939 A1
(43) Pub. Date: Dec. 2, 2010

(54) Insect Repellling Paint

(76) Inventors: Luis Manuel Ribeiro Mota, Jandira (BR); Maria Angela Pereira, Sao Paulo-SP (BR); Valter Lopes Da Silva, Sao Bernardo do Campo (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/676,711

(22) PCT Filed: Sep. 11, 2007
(86) PCT No.: PCT/BR07/00232

§ 371 Date: Jun. 7, 2010

(51) Int. Cl. A01N 65/26; A01P 7/04; C08K 5/09; B32B 21/04; B32B 9/00; B32B 15/04; B32B 11/04; B32B 17/06

(52) U.S. Cl. 424/769; 524/300; 428/537.1; 428/688; 428/457; 428/489; 428/532; 428/426

(57) ABSTRACT

Insect repelling paint compositions include a binder, a solvent, and an amount of Andiroba oil. The compositions may have from about 1 to about 25% by weight, and preferably around 5% by weight of the Andiroba oil. A method of making such paint compositions is disclosed. Methods for imparting or improving the insect repellency of paints and painted surfaces are also described.

### BACKGROUND

Latex paint and coating compositions are commonly used for in both interior and exterior applications for providing protective and/or decorative coatings to walls or other surfaces. Latex paint compositions usually comprise water and a dispersed polymeric binder. The binder may be selected from various known polymeric binders such as vinyl, acrylic or urethane polymers. Latex paints also may comprise one or more pigments.

Latex paint is widely used in regions having significant insect activity and where infestations of insects, such as flies, mosquitoes, roaches, and spiders, into homes, restaurants, and other commercial and residential buildings are common. Such infestations are generally bothersome and in some instances, can be dangerous. Some types of insects are known carriers of disease. Insects can destroy food stores and clothing and undermine a building's structural integrity, by eating or boring into the substrate. Moreover, insect infestations can be very difficult and expensive to get rid of and, often, treatments involve the use of chemicals that can be harmful to humans or animals that reside in the building.

Rather than treating an infestation, it would be desirable to inhibit insects from entering or staying in the building. While physical (e.g., screens) and insecticidal boundaries at the exterior of the building may be useful deterrents to insect entry, insecticidal boundaries in particular can be washed away or the chemicals may be harmful or irritating to humans and animals and physical boundaries can be expensive to install and maintain, and very small insects can often exploit gaps in the boundary. Moreover, these types of boundaries are unhelpful once an infestation has occurred.

It would be useful if the surfaces of a building could be made more inhospitable to insects by imparting to them insect repellent characteristics. By limiting the surfaces on which insects can travel and rest, it may be possible to deter or reduce the size of infestations.

It is believed that insect repellent characteristics can be imparted to many interior and exterior building and structural surfaces by coating them with a paint that has insect repelling properties and that provides a dried film having insect repelling properties. In this way, a single application, which may entail one or more coats, of paint could confer a measure of insect repellency to the coated surface. Using paint as a medium for imparting insect repellency is desirable because paint is widely used for decorative purposes and, therefore, is applied extensively to surfaces throughout buildings. Additionally, by incorporating insect repellency into the paint, the repellency is a passive byproduct of the painting process and does not necessitate additional topcoats of insecticides or insect repellents as would otherwise be necessary to achieve similar surface coating properties.

It would, therefore, be useful to provide an insect repelling paint that is safe for application in occupied buildings and that is not generally irritating to humans and domestic animals that might come into contact with the paint or coated surfaces. It would also be useful to provide a paint in which the insect repelling agent(s) is stabile in the liquid paint and remain active after the paint has dried on the surface.

### DETAILED DESCRIPTION OF THE INVENTION

The present invention relates to a paint, most usefully, a latex paint, which, in some embodiments, may deter or repel insects from walking or landing on a surface coated with the paint or eating or boring through the coated surface. In the embodiments of the present invention, the paints comprise a an amount of Andiroba oil, added to or during the manufacturing of the paint as an insect repelling agent to impart to the paint insect repelling properties.

While it is contemplated that the paint compositions of the present invention may repel a wide variety of insects, it is believed that some embodiments of the paints may be particularly useful in repelling certain types of roaches, such as American Periplaneta; mosquitoes, such as Aedes aegypti; flies, such as the common Musca domestica; and spiders, such as the redlegged house spider Nesticodes rufipes.

Andiroba oil is a naturally occurring oil obtained in some instances from the seeds or nuts of the Carapa guianensis tree, which grows throughout Central and South America. The oil and other extracts from the bark, leaves and seeds of the Carapa guianensis tree have been recognized for use in a variety of ethnomedicinal treatments and applications for illnesses and conditions ranging from fever to skin lesions. In teachings related to its use as a medical treatment, Andiroba oil has been described as having use topically on human and animal skin and for use in concoctions to be ingested. Andiroba oil also has natural insect repellant properties.

In accordance with the present invention, insect repelling paint may be made by post-adding Andiroba oil to an existing or otherwise commercially available paint formulation, such as a latex paint. In another embodiment, Andiroba oil may be incorporated into a paint composition during the manufacture of the paint. This will be described in more detail herein. As indicated above, Andiroba oil is naturally occurring and has been made commercially available, including from Cognis (CEGESOFT CGO).

It is believed that Andiroba oil may be included in paint formulations of the present invention in amounts up to about 25% by weight of a total paint formulation, and in other embodiments, up to about 20% or 15% or 10% by weight. In some embodiments, insect repellent paint may comprise Andiroba oil in amounts from about 1% to about 10% by weight of a total paint formulation, and in still other embodiments, from about 2% to about 7% by weight, and in still further embodiments, about 4% to about 6% by weight, and in a particularly useful embodiment, at about 5% by weight of the total formulation.

In one useful embodiment of the present invention, Andiroba oil may be added up to the maximum amount wherein the oil will remain in stable solution in the paint.

It is contemplated that paint formulations containing Andiroba oil, as described herein, will be capable of repelling insects from walking on or landing on, eating, or boring through surfaces on which the paint has been applied, and more specifically, the dried paint film.

It is contemplated that a particularly useful paint formulation comprises, in addition to the Andiroba oil, a binder, which may be a latex binder, and water or other appropriate solvent.

As indicated, the paint compositions may comprise a latex binder. The term latex is well known in the paints and coatings field to mean a two phase system wherein there exists a first continuous phase which comprises water, water soluble additives such as emulsifiers and the like and water soluble or compatible solvents. There also exists a second discontinuous or dispersed phase which is dispersed in the first phase. This second phase comprises polymeric particles and other ingredients which, when applied to a substrate and allowed to dry, form the basis for the continuous coating film.

Latexes of particular usefulness in the present invention may include those which comprise polymers derived from acrylic and other monomers such as, for example, alkyl or aryl esters of unsaturated carboxylic acids including acrylates and methacrylates such as ethyl acrylate, 2-ethylhexyl acrylate, methyl methacrylate, butyl acrylate, phenylacrylate and the like. In addition, acrylic copolymers derived from the above acrylic monomers and other monomers such as, for example, aliphatic and aromatic monomers such as ethylene, butadiene, styrene and vinyl toluene, vinyl halides such as vinyl chloride, vinyl bromide, and vinylidene chloride, unsaturated nitriles such as acrylonitrile and methacrylonitrile, unsaturated amides such as acrylamide, N-substituted acrylamide, and methacrylamide, unsaturated carboxylic acids such as acrylic acid, methacrylic acid and maleic acid or anhydride, and fumaric acid, and other polymerizable monomers of various types may be utilized. Hydroxy-functional monomers such as hydroxy ethyl acrylate and methacrylate may be included.

The latex polymers may be prepared by free-radical initiated emulsion polymerization techniques which are well known in the industry.

Paint compositions in which the Andiroba oil may be usefully added generally contain from about 2% to about 80% by weight binder, for example, about 10% to about 50%. Binders useful in latex paint compositions are described above and may include polymeric or non-polymeric binders. The water content of the latex paint may be from about 30% to about 65%, for instance from about 40% to about 55%. The composition may also include thickeners, such as urethane thickeners, hydroxyethyl cellulose thickeners, and acrylic thickeners in amounts up to about 2% by weight, for example about 0.3% to about 1.5%. The content of inorganic materials may be from about 15% to about 45% by weight, for example, about 20% to about 35%. Such inorganic components may comprise titanium dioxide (e.g. 0 to about 30% titanium dioxide) based on the nature of the coating compositions. Other colored pigments may also be used alone or in combination to produce a wide range of colored paint. Suitable additional pigments may include calcium carbonate, talc, clay, silicates, aluminum silicates, calcium metasilicates, aluminum potassium silicates, magnesium silicates, barium sulfates, nepheline syenite, feldspar, zinc oxides or sulfides, or others known to those skilled in the art. Such pigments may be included in amounts up to about 60% by weight, for example, about 10% to about 20%. Synthetic organic materials might also be incorporated; these include plastic beads, hollow spheres or other similar materials. Other optional components include glycols such as ethylene and/or propylene glycol in amounts from 0 to about 7% and other solvents such as diethylene glycol dibenzoate and dipropylene glycol dibenzoate in amounts up to about 3%. The coating composition may also contain pigment dispersing agents which can be solvents or surfactants; biocides such as amine or sulfur compounds, halogen donors, or metals; fungicides, foam control agents such as oils, fatty acids and silicones; slip and mar additives; adhesion promoters, co-solvents, and/or other known paint additives.

In use in paint formulations, Andiroba oil may be added to an existing paint. In another embodiment, the Andiroba oil may be added during manufacture of the paint. In still another embodiment, a portion of the Andiroba oil may be added during manufacture while another portion may be post-added to the finished paint. In one useful embodiment, adjustments may be made to the remainder of the paint formulation to accommodate for the additional liquid (namely, Andiroba oil) incorporated into the paint. Such modifications would be understood by those skilled in the art.

The paint formulations may be applied to one or more surfaces by methods well known in the art such as air-assisted or airless spray, brush, roller squeegee, roll coater, curtain coater, and the like. Substrates to which the paint compositions may be applied include, for example, natural timber, processed timber including but not limited to medium density fiber board, chip board, laminates; mineral substrates including but not limited to masonry, concrete, stucco, fiber, mortar, cement, cement asbestos, plaster, plasterboard, glazed and unglazed ceramic; metal including but not limited to galvanized iron, galvanized steel, cold rolled steel, aluminum, wrought iron, drop forged steel, and stainless steel; synthetic substrates including but not limited to polyvinyl chloride, polyvinylidene chloride, polyethylene, and polypropylene; asphalt; cellulosic substrates such as paper, paperboard, wallpaper, and wallboard; glass; and leather. The coating composition may be used, for example, as a wood coating, maintenance coating, interior or exterior wall or other architectural coating, metal coating, plastics coating, concrete paint, furniture paint, and the like. The coatings may be flat coatings, satin coatings, semi-gloss coatings, gloss coatings, textured coatings, and the like.

It is generally useful for the paint formulation to be applied as a topcoat, rather than as a primer coat or undercoat, as application of a non-treated topcoat of paint to the coatings described herein may reduce or negate the insect repellency imparted by the treated coating.

The present invention will be better understood by reference to the following examples, which are provided for purposes of illustration only and are not to be construed as limiting the scope of the present invention. As used in the example, unless otherwise noted, “Parts by Weight” means weight percent.

### Example 1

A representative insect repelling latex coating composition may be prepared by admixing the following ingredients:

| Raw Material | Parts by Weight |
|---|---|
| Styrene Acrylic Latex¹ | 31.00 |
| Titanium Dioxide slurry² | 21.00 |
| Water | 14.16 |
| Calcium Carbonate slurry³ | 12.00 |
| Andiroba oil | 5.00 |
| Pyrophilite slurry⁴ | 5.00 |
| Opaque Polymer⁵ | 5.00 |
| Diluent⁶ | 5.00 |
| Thickener⁷ | 0.75 |
| Defoamer⁸ | 0.40 |
| Tetra-potassium pyrophosphate | 0.20 |
| Fungicide⁹ | 0.20 |
| AMMONIA 24/25% | 0.12 |
| Bactericide¹⁰ | 0.12 |
| Sodium Nitrite | 0.05 |

In this example, the Andiroba oil may be blended during the manufacture of the paint.
¹A proprietary styrene acrylic latex of the assignee of this application.
²Such slurries are commercially available and generally comprise various combinations of dry pigment and one or more of: dispersant and/or surfactant, buffer, biocide, water, and/or defoamers.
^{3,4}These slurries comprise, respectively, calcium carbonate and pyrophilite in one or more of: water, dispersant and/or surfactant, buffer, biocide, water, and/or defoamers.
⁵ROPAQUE ULTRA from Rohm & Haas.
⁶A blend of Primal RM 5 @ 12% (from Rohm & Haas) + Exxsol D-40 28.8% (from ExxonMobil) + Ethyleno Glycol 2.6% in water plus surfactant, buffer, biocide, water, and/or defoamers.
⁷PRIMAL DR-73 from Rohm & Haas.
⁸ANTAROL TS-709 from The Lubrizol Corporation.
⁹BIOCIDA FBP-490 from Ipel Itibanyl Produtos Especiais.
¹⁰BIOCIDA BP-507 from Ipel Itibanyl Produtos Especiais.

While the present invention has been illustrated by the description of embodiments thereof, and while the embodiments have been described in considerable detail, it is not the intention of the applicants to restrict or in any way limit the scope of the appended claims to such detail. For example, although the invention has been described with reference to latex paints, it is contemplated that the concepts herein may also be applicable to other types of paints that are known in the art. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A paint composition comprising:
a binder;
water;
and Andiroba oil.

2. The paint composition of claim 1, wherein the Andiroba oil comprises up to about 25% by weight of the paint composition.

3. The paint composition of claim 2, wherein the Andiroba oil comprises from about 1% to about 10% by weight of the paint composition.

4. The paint composition of claim 1, wherein the binder is a latex binder.

5. The paint composition of claim 4, wherein the binder is a styrene acrylic latex binder.

6. The paint composition of claim 1, further comprising a pigment.

7. The paint composition of claim 6, wherein the Andiroba oil comprises from about 1% to about 10% by weight of the paint composition.

8. A process for making an aqueous latex-based coating material insect repelling comprising adding Andiroba oil to a coating material during or after its manufacture.

9. A process for repelling insects from a substrate comprising:
applying a paint to a substrate, the paint comprising a binder and Andiroba oil;
and allowing the paint to dry.

10. The process of claim 9, wherein the paint comprises a latex binder and water.

11. The process of claim 10, wherein said paint comprises from about 1% to about 10% by weight of the Andiroba oil.

12. The process of claim 9, wherein the substrate is selected from the group consisting of natural timber substrates, processed timber substrates, mineral substrates, metal substrates; synthetic substrates, asphalt substrates; cellulosic substrates, and glass substrates.

13. The process of claim 12, wherein the substrate is inside a building.

14. An article comprising:
a substrate coated with a paint, wherein the substrate is selected from the group consisting of natural timber substrates, processed timber substrates, mineral substrates, metal substrates; synthetic substrates, asphalt substrates; cellulosic substrates, and glass substrates, and
wherein the paint comprises a binder and Andiroba oil.

15. The article of claim 14, wherein the paint comprises a latex binder.

16. The article of claim 15, wherein the paint comprises from about 1% to about 10% by weight of the Andiroba oil.

17. The article of claim 16, wherein the paint comprises about 5% by weight of the Andiroba oil.
